(19) United States
(12) Patent Application Publication
(10) Pub. No.: US 2004/0055019 A1
(43) Pub. Date: Mar. 18, 2004

(54) Method for controlling an apparatus with a broadcast signal and apparatus therefor

(75) Inventor: George Marmaropoulos, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/242,253

(22) Filed: Sep. 12, 2002

(51) Int. Cl. H04N 7/20; H04N 7/173; H04N 7/16; H04N 7/00; H04N 11/00

(52) U.S. Cl. 725/133; 348/552; 348/460; 725/141

(57) ABSTRACT

A receiving device including: a receiver for receiving a broadcast signal for controlling a behavior of the receiving device, the broadcast signal being broadcast within a predetermined area; one or more output devices; and a processor for converting the broadcast signal into one or more control signals and controlling the one or more output devices according to the one or more control signals. The receiving device is preferably a toy, a novelty device, a sporting aid, an educational aid, or a weather indicator. The broadcast signal is preferably a radio broadcast signal, a cellular broadcast signal, or a satellite broadcast signal.

### BACKGROUND OF THE INVENTION

1. Field of the Invention

The present invention relates generally to methods for controlling an apparatus with a broadcast signal, and more particularly, to devices such as toys, novelty devices, sporting aids, educational aids, and weather indicators which are controlled by a broadcast radio signal. Hereinafter, toys, novelty devices, sporting aids, educational aids, weather indicators and other like devices will be referred to generally as a receiving device.

2. Prior Art

Toys, educational aids and other receiving devices are known in the art that react to control signals from an internal processor and/or from a personal computer. Such toys operate in a controlled manner to perform in a known way according to a script stored in memory operatively connected to the internal processor and/or personal computer. Before long, the toy's behavior becomes predictable. Thus, the user of the toy knows all of the programmed scripts and becomes bored with the toy. In the case of educational aids, the user quickly advances past the lessons taught by the educational aid and they too become bored. Upgrades to the toy's and educations aid's behavior programming may be obtained, however, such upgrades are expensive and a nuisance.

Therefore, there is a need in the art for toys, educational aids, and other receiving devices that have an unpredictable behavior and can be easily and inexpensively updated.

### SUMMARY OF THE INVENTION

Therefore it is an object of the present invention to provide a toy, educational aid, and other receiving devices, and method for control thereof that can be controlled in an unpredictable manner.

It is another object of the present invention to provide a toy, educational aid, and other receiving devices, and method for control thereof that can be controlled by a broadcast signal, such as a radio or cellular broadcast signal.

It is still a further object of the present invention to provide a toy, educational aid, and other receiving devices, and method for control thereof that can be changed inexpensively and conveniently.

Accordingly, a receiving device is provided. The receiving device comprises: a receiver for receiving a broadcast signal for controlling a behavior of the receiving device, the broadcast signal being broadcast within a predetermined area; one or more output devices; and a processor for converting the broadcast signal into one or more control signals and controlling the one or more output devices according to the one or more control signals.

Preferably, the receiving device is selected from a group consisting of a toy, a novelty device, a sporting aid, an educational aid, and a weather indicator.

The broadcast signal is preferably selected from a group consisting of a radio broadcast signal, a cellular broadcast signal, and a satellite broadcast signal.

Preferably, the broadcast signal is a radio broadcast signal having a predetermined frequency in which case the receiving device preferably further comprises a radio tuner for varying the predetermined frequency. Preferably, the broadcast signal is embedded in a radio program signal and the receiving device further comprises means for separating the embedded broadcast signal from the radio program signal.

The one or more output devices are preferably selected from a group consisting of a motor, speaker, and light.

Also provided is a system for controlling a receiving device where the system comprises: a broadcaster for broadcasting a broadcast signal within a predetermined area to control a behavior of the receiving device; and a receiving device comprising a receiver for receiving the broadcast signal within the predetermined area, one or more output devices, and a processor for converting the broadcast signal into one or more control signals and controlling the one or more output devices according to the one or more control signals.

Preferably, the broadcaster is selected from a group consisting of a radio broadcaster, a cellular broadcaster, and a satellite broadcaster.

The broadcast signal is either a dedicated signal for the control of the one or more output devices of the receiving device or alternatively the broadcast signal is transmitted in parallel with a main signal selected from a group consisting of a radio program signal, a cellular message signal, and a satellite content signal.

Preferably, the receiving device is selected from a group consisting of a toy, a novelty device, a sporting aid, an educational aid, and a weather indicator.

The one or more output devices are preferably selected from a group consisting of a motor, speaker, and light.

Still yet provided is a method for controlling a behavior of a receiving device from a broadcast signal which is broadcast within a predetermined area. The method comprises: receiving the broadcast signal at the receiving device; converting the broadcast signal into one or more control signals; and controlling one or more output devices associated with the receiving device according to the one or more control signals.

The method preferably further comprises broadcasting the broadcast signal to the predetermined area.

Preferably, the broadcasting comprises broadcasting a radio broadcast signal having a predetermined frequency, the method further comprising varying the predetermined frequency.

The receiving device is preferably in the form of an animal and has at least one of arms, legs, head, and fingers, wherein the controlling step comprises controlling a movement of at least one of the arms, legs, head, and fingers. Preferably, the receiving device further has at least one light, wherein the controlling step comprises controlling activation of the at least one light. More preferably, the receiving device further has at least one speaker, wherein the controlling step comprises outputting a sound from the at least one speaker.

The method preferably further comprises demonstrating one of an advertisement, weather indication, exercise instruction, story telling, alarm indication, and educational instruction to a user of the receiving device from the control of the one or more output devices.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematic view of a system for controlling a receiving device of the present invention.

FIG. 2 illustrates a schematic view of a preferred receiving device of the present invention, configured as a toy.

### DETAILED DESCRIPTION OF THE PREFERRED EMBODIMENT

Although this invention is applicable to numerous and various types of receiving devices and broadcast signals, it has been found particularly useful in the environment of toys and educational aids that are controlled by a radio broadcast signal. Therefore, without limiting the applicability of the invention to toys and educational aids that are controlled by a broadcast signal, the invention will be described in such environment. Those skilled in the art will appreciate that the receiving devices of the present invention can also be configured as a novelty device, weather indicator and sporting aid as well as other controllable receiving devices. Furthermore, those skilled in the art will further appreciate that such receiving devices can be controlled by other types of broadcast signals, such as cellular and satellite signals.

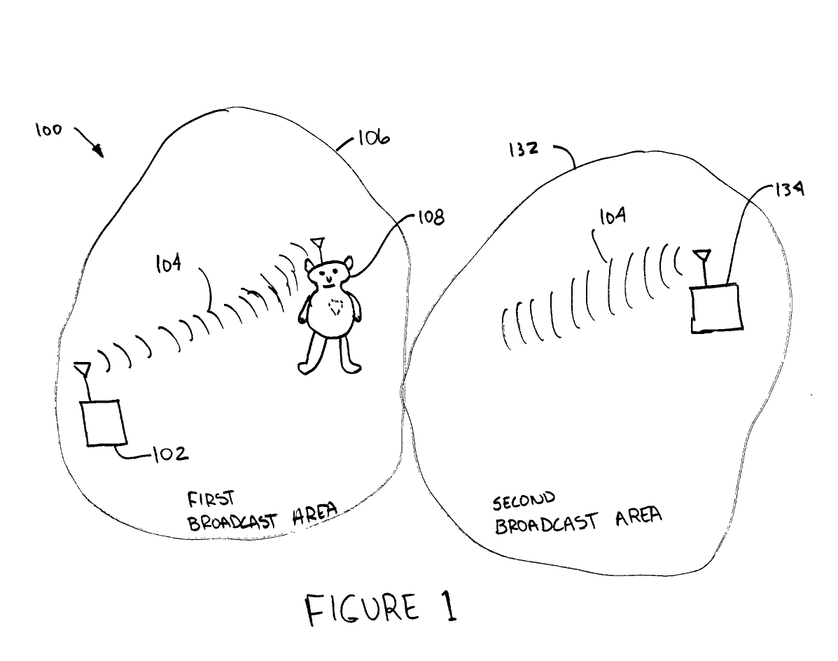

Referring now to FIG. 1, there is shown a system for controlling a receiving device, the system being generally referred to by reference numeral 100. The system 100 comprises a first broadcaster 102 for broadcasting a broadcast signal 104 within a first predetermined area 106 to control a behavior of any receiving device 108 within the first predetermined area 106. The first broadcaster 102 is preferably a radio broadcaster, but may also be other types of broadcasters, such as, a cellular broadcaster, and a satellite broadcaster. The radio signals 104 from the radio broadcaster 102 are broadcast by a radio station which is either dedicated to transmit the signal 104 for control of the receiving device 108 or by a participating radio station which can transmit the signal 104 in parallel with a main signal from a regular radio program. The broadcast signal 104 is preferably an inaudible AM or FM signal, but may also be audible. Where the broadcaster 102 is a cellular broadcaster or a satellite broadcaster, the main signal consists of a cellular message signal and a satellite content signal, respectively.

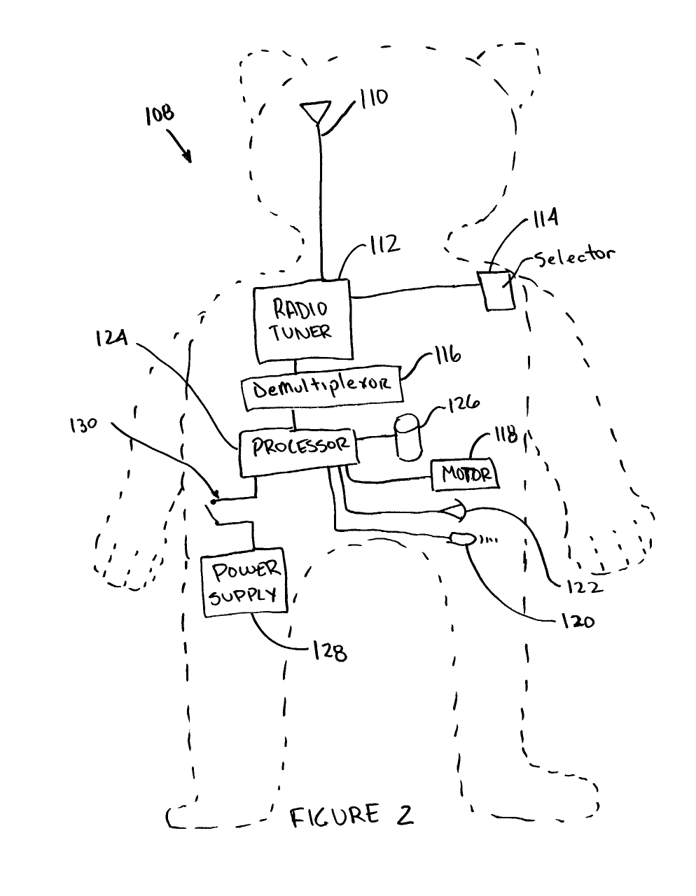

Referring now to FIG. 2, there is shown a schematic of a preferred receiving device 108 of FIG. 1. The receiving device 108 generally comprises a receiver 110 for receiving the broadcast signal 104 from the broadcaster 102. The broadcast signal 104 is used by the receiving device 108 for controlling a behavior of the receiving device 108 as will be discussed below with regard to several examples. The receiving device 108 is preferably configured as a toy, such as a teddy bear. However, those skilled in the art will appreciate that the receiving device 108 can be configured in a number of ways, such as a novelty device, a sporting aid, an educational aid, and a weather indicator.

The broadcast signal 104 received by the receiving device 108 has a predetermined frequency, which may be fixed or variable. In the case where the broadcast signal 104 received by the receiving device 108 is variable, the receiving device 108 further has a tuning means for varying the predetermined frequency. Where the broadcast signal 104 is a radio program broadcast, the tuning means is a radio tuner 112 and a selection means 114 (e.g., a tuning knob) for selecting the predetermined frequency. Furthermore, where the broadcast signal 104 is embedded in a main signal, such as a radio program signal, the receiving device further has means for separating the embedded broadcast signal 108 from the radio program signal, such as a demultiplexer 116. The tuning means and demultiplexing means are well known in the arts of radio receivers and communications in general.

The receiving device 108 further has one or more output devices, such as one or more motors 118, lights 120, and speakers 122. FIG. 2 illustrates one of each such output device. Those skilled in the art will appreciate that one or more of each of such devices may be used in the receiving device 108 without departing from the spirit or scope of the present invention. For instance, if the receiving device 108 is configured as an animal (including a person), motors 118 can be provided at each limb, at the neck, the head, the mouth, the eyes, and the fingers and toes to mimic the movement of the animal. Motors 118 can also be used to control appendages connected to the receiving device 108, such as an umbrella. One or more speakers 122 are used to make sounds, play music, and/or reproduce a speaking or singing voice. Furthermore, one or more lights 120 are used to light certain parts of the receiving device 108, such as its eyes and/or heart or to produce a light display, preferably in synchronization with sound from the speaker 122, such as a song. Furthermore, it is understood that the output devices include any additional hardware or software for their proper operation, such as starting capacitors and software drivers.

The receiving device 108 further has a processor 124 for converting the broadcast signal directly from the radio tuner 112 or appropriately demultiplexed from the multiplexer 116 into one or more control signals for control of the one or more output devices. The processor 124 also generally controls the overall function of the receiving device 108 including the synchronization of the output devices to control a certain behavior of the output device 108. The control of the output devices for any given broadcast signal or portion thereof is preferably stored in an attached memory 126, preferably in the form of a look-up table or according to a stored program or algorithm. The receiving device 108 further has a power supply 128, which is preferably a portable power supply, such as commercially available battery cells and an on-off switch 130 for selectively connecting and disconnecting the power supply 128 to the processor 124 and other components of the receiving device 108. Although not shown, the receiving device 108 may have other switches for carrying out switching functions such as changing the way the receiving device 108 behaves for any given broadcast signal 104 or for changing a mode of operation of the receiving device 108, for example from a toy to a educational aid or from a predetermined mode of behavior to a random mode of behavior.

### EXAMPLES

### Example 1

In a first example, the receiving device 108 is configured as a teddy bear and has motors 118 for moving its head and arms, and to open and close its eyes. The teddy bear receiving device 108 further has a speaker 122 and lights 120 that allow part of its body (e.g. his heart) to be illuminated. The teddy bear receiving device 108 is pre-tuned to a certain radio frequency (tuning to other frequencies is also possible with the tuning means discussed above) that is broadcast in parallel with a radio program broadcast from a first local participating radio broadcasting station 102. The radio-broadcasting station 108 sends one night the appropriate broadcast signal 104 embedded to an advertisement. The teddy bear receiving device 108 receives the advertisement and demultiplexes the broadcast signal 104 therefrom. The broadcast signal 104 is input into the processor 124 where the broadcast signal 104 is converted into appropriate control signals for the control of the motor 118, speaker 122, and lights 120. In a first embodiment, the teddy bear can start moving its arms and yawning and closes its eyes to go to sleep. In the morning the teddy bear can “wake up” by opening its eyes, lighting up, and or saying a song or telling a story etc. The storytelling can be combined with a display of the lights 120 and/or bodily movements controlled by the motors 118. The song or story can be stored in memory and retrieved by control signal from the processor according to the broadcast signal 102. Alternatively, the song and/or story can be carried out by control signals entirely in the broadcast signal 102 and relayed through the processor 124 to the appropriate output devices.

There is also the possibility of calling the radio station broadcaster 102 and dedicating a behavior to a friend. As radio stations are local, when traveling, the behavior of the receiving device 108 can change to reflect some of the local identity. For example, when the teddy bear enters a different part of the country, illustrated as a second broadcast area 132 in FIG. 1, the broadcast signal 104 broadcast by the second broadcaster 134 could be used to control the speaker 122 to change the accent of the teddy bear receiving device 108 when it tells stories or otherwise talks. The broadcast signal 102 from the second broadcaster 134 can also reflect other characteristics unique to the second broadcast area 132, such as its weather and attractions.

### Example 2

In Example 1, the radio broadcast signal 104 can be used to remind children that it is time to eat, to read, or to go to bed because the reminders can be broadcast by the radio station broadcaster 102 at an appropriate time for such behaviors.

### Example 3

The receiving device 108 can also be used for educational and other activities, such as physical exercises. For instance, the teddy bear receiving device 108 of Example 1 can be equipped with an umbrella having motors 118 for controlling an opening and closing of the umbrella. If rain is in the forecast, the radio station broadcaster 102 can broadcast an appropriate broadcast signal 104 that is interpreted by the processor 124 to open the umbrella. Furthermore, the receiving device 108 can be configured as a person or a representative characterture thereof. At a certain time of day, the radio station broadcaster 108 can broadcast a broadcast signal 104 that is interpreted by the processor 124 to control the speaker and/or body movements to remind a user to exercise, or even on how to do certain exercises.

### Example 4

The receiving device 108 can also be used for advertisement behaviors and therefore generate an additional revenue stream for the broadcaster 102. For instance, when traveling from a first broadcast area 106 to a second broadcast area 132, the receiving device 108 can start to receive a broadcast signal from the second broadcaster 134 (preferably a radio station). The broadcast signal 104 from the second broadcaster 134 can be interpreted by the processor 118 to drive the speaker 122 to tell the user of certain sales or events in the second broadcast area 132.

Those skilled in the art will appreciate that the behavior of the receiving device 108 can change in an unpredictable way for his owner because it is based on what behavior is broadcast by the broadcaster 102 during the period of the day, the day of the week etc. and also depending upon the geographical location of the receiving device. This gives to the receiving device 108 an element of surprise and magic.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device such as memory 126.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A receiving device comprising:
a receiver for receiving a broadcast signal for controlling a behavior of the receiving device, the broadcast signal being broadcast within a predetermined area;
one or more output devices; and
a processor for converting the broadcast signal into one or more control signals and controlling the one or more output devices according to the one or more control signals.

2. The receiving device of claim 1, wherein the receiving device is selected from a group consisting of a toy, a novelty device, a sporting aid, an educational aid, and a weather indicator.

3. The receiving device of claim 1, wherein the broadcast signal is selected from a group consisting of a radio broadcast signal, a cellular broadcast signal, and a satellite broadcast signal.

4. The receiving device of claim 1, wherein the broadcast signal is a radio broadcast signal having a predetermined frequency.

5. The receiving device of claim 4, further comprising a radio tuner for varying the predetermined frequency.

6. The receiving device of claim 4, wherein the broadcast signal is embedded in a radio program signal, the receiving device further comprising means for separating the embedded broadcast signal from the radio program signal.

7. The receiving device of claim 1, wherein the one or more output devices are selected from a group consisting of a motor, speaker, and light.

8. A system for controlling a receiving device, the system comprising:
a broadcaster for broadcasting a broadcast signal within a predetermined area to control a behavior of the receiving device; and
a receiving device comprising a receiver for receiving the broadcast signal within the predetermined area, one or more output devices, and a processor for converting the broadcast signal into one or more control signals and controlling the one or more output devices according to the one or more control signals.

9. The system of claim 8, wherein the broadcaster is selected from a group consisting of a radio broadcaster, a cellular broadcaster, and a satellite broadcaster.

10. The system of claim 8, wherein the broadcast signal is a dedicated signal for the control of the one or more output devices of the receiving device.

11. The system of claim 8, wherein the broadcast signal is transmitted in parallel with a main signal selected from a group consisting of a radio program signal, a cellular message signal, and a satellite content signal.

12. The system of claim 8, wherein the receiving device is selected from a group consisting of a toy, a novelty device, a sporting aid, an educational aid, and a weather indicator.

13. The system of claim 8, wherein the one or more output devices are selected from a group consisting of a motor, speaker, and light.

14. A method for controlling a behavior of a receiving device from a broadcast signal which is broadcast within a predetermined area, the method comprising:
receiving the broadcast signal at the receiving device;
converting the broadcast signal into one or more control signals; and
controlling one or more output devices associated with the receiving device according to the one or more control signals.

15. The method of claim 14, further comprising broadcasting the broadcast signal to the predetermined area.

16. The method of claim 15, wherein the broadcasting comprises broadcasting a radio broadcast signal having a predetermined frequency, the method further comprising varying the predetermined frequency.

17. The method of claim 14, wherein the receiving device is in the form of an animal and has at least one of arms, legs, head, and fingers, wherein the controlling step comprises controlling a movement of at least one of the arms, legs, head, and fingers.

18. The method of claim 17, wherein the receiving device further has at least one light, wherein the controlling step comprises controlling activation of the at least one light.

19. The method of claim 17, wherein the receiving device further has at least one speaker, wherein the controlling step comprises outputting a sound from the at least one speaker.

20. The method of claim 14, further comprising demonstrating one of an advertisement, weather indication, exercise instruction, story telling, alarm indication, and educational instruction to a user of the receiving device from the control of the one or more output devices.
